(19) United States
(12) Patent Application Publication
(10) Pub. No.: US 2021/0128273 A1
(43) Pub. Date: May 6, 2021

(54) ORTHODONTIC ELASTIC MONITORING METHODS AND DEVICES

(71) Applicant: Robert Kelleher, Folsom, CA (US)

(72) Inventor: Robert Kelleher, Folsom, CA (US)

(21) Appl. No.: 17/259,146

(22) PCT Filed: Jul. 11, 2019
(86) PCT No.: PCT/US19/41442

§ 371 Date: Jan. 8, 2021

Related U.S. Application Data
(60) Provisional application No. 62/696,629, filed on Jul. 11, 2018.

(51) Int. Cl. A61C 7/00; A61C 7/36; A61C 7/30

(52) U.S. Cl. CPC A61C 7/002; A61C 7/303; A61C 7/36

(57) ABSTRACT

Disclosed are devices, systems and methods for monitoring usage of an elastic component of an orthodontic article. In some aspects, an apparatus for monitoring elastics usage with an orthodontic article includes a sensor to detect a physical parameter associated with an elastic component when the elastic component is coupled to the orthodontic article, wherein the sensor is attachable to the orthodontic article or to the elastic article and operable to transduce the detected physical parameter into an electrical signal; a data processing unit, comprising a processor and a memory, in communication with the sensor to receive the electrical signal from the sensor and to process the electrical signal as data to be stored or transmitted by the apparatus; and a power source to supply power to the sensor and to the data processing unit.

### CROSS-REFERENCE TO RELATED APPLICATIONS

This patent document claims priorities to and benefits of U.S. Provisional Patent Application No. 62/696,629 entitled “ORTHODONTIC ELASTIC MONITORING METHODS AND DEVICES” filed on Jul. 11, 2018. The entire content of the aforementioned patent application is incorporated by reference as part of the disclosure of this patent document.

### TECHNICAL FIELD

This patent document is directed generally to orthodontic articles.

### BACKGROUND

The goal of orthodontic treatment is not only to create a beautiful smile, but also a functional bite. The result of an orthodontic treatment should be well-aligned teeth that look great while also allowing the patient's teeth and jaw movements to relate well within a standard that supports jaw joint health, enamel integrity, airway patency, periodontal integrity, as well as head and neck muscle balance and comfort. Notably, orthodontic care that lacks a functional bite can threaten or limit the long-term durability of the patient's teeth, optimal anatomical relationships of muscles, jaw joints, enamel integrity and periodontal status due to compensatory parafunctional grinding and/or clenching. Poor anatomical relationships can negatively impact breathing function, chewing function and comfort, as well. A corrected bite tends to also reduce the risk of negative nutritional effects secondary to poor function, some speech compromises, some headache pain, quality of life setbacks from muscle pain or fatigue, and lowering of self-esteem.

### SUMMARY

Disclosed are apparatuses, systems and methods for monitoring adherence and compliance of orthodontic elastic component use with an orthodontic device by a patient. In some aspects, a monitoring device is configured to measure parameter(s) indicative of an elastic component being worn by an orthodontics patient utilizing an electronic sensor device or a mechanical sensor device configured with the patient's orthodontics article (e.g., braces, clear aligners, or other).

In some aspects, an apparatus for monitoring elastics usage with an orthodontic article includes a sensor to detect a physical parameter associated with an elastic component when the elastic component is coupled to the orthodontic article, wherein the sensor is attachable to the orthodontic article or to the elastic article and operable to transduce the detected physical parameter into an electrical signal; a data processing unit, comprising a processor and a memory, in communication with the sensor to receive the electrical signal from the sensor and to process the electrical signal as data to be stored or transmitted by the apparatus; and a power source to supply power to the sensor and to the data processing unit.

In some aspects, a method for monitoring elastics usage with an orthodontic article includes detecting, over a time period, a parameter associated with usage of an elastic article when the elastic article coupled to the orthodontic article; processing the detected parameter to estimate a time duration the elastic article was coupled with the orthodontic article during the time period; and determining whether the time duration meets or exceeds a predetermined temporal threshold.

### BRIEF DESCRIPTION OF THE DRAWINGS

FIGS. 1A and 1B show diagrams illustrating the movement of the upper and lower teeth based on using an orthodontic article or treatment.

FIG. 2 shows a block diagram of an example embodiment of a device for orthodontic elastic component monitoring in accordance with the disclosed technology.

FIGS. 3A and 3B show block diagrams of example components of device for orthodontic elastic component monitoring in accordance with the disclosed technology.

FIG. 4 shows a diagram of an example embodiment of the device for orthodontic elastic component monitoring shown in FIG. 2.

FIGS. 5A and 5B show different views of examples of the device shown in FIG. 4 used for orthodontic elastic component monitoring.

FIGS. 6A and 6B show diagrams of different exemplary use cases of the device shown in FIG. 4 used for orthodontic elastic component monitoring.

FIG. 7 shows a diagram of an example embodiment of the device for orthodontic elastic component monitoring shown in FIG. 2.

FIGS. 8A-8C show different views of examples of the device shown in FIG. 7 used for orthodontic elastic component monitoring.

FIGS. 9A and 9B show diagrams of different exemplary use cases of the device shown in FIG. 7 used for orthodontic elastic component monitoring.

FIG. 10A shows a flowchart of an example method for orthodontic elastic component monitoring in accordance with the disclosed technology.

FIG. 10B shows a diagram of an example report associated with orthodontic elastic component monitoring.

FIG. 11 shows a diagram of an example embodiment of a system in accordance with the disclosed technology that integrates the device for orthodontic elastic component monitoring with remote devices and cloud-based services.

### DETAILED DESCRIPTION

Most orthodontic problems (malocclusions) are inherited, and examples of these genetic problems include crowding, spacing, protrusion, extra or missing teeth, and some jaw growth problems. Orthodontic treatment creates a better bite, making teeth fit better, and decreases the risk of future and potentially costly dental problems. Crooked and crowded teeth are hard to clean and maintain. A malocclusion can cause tooth enamel to wear abnormally, difficulty in chewing and/or speaking, and excess stress on supporting bone and gum tissue. Without treatment, many problems simply become worse.

Achieving orthodontic correction of a patient's bite using an orthodontics device, such as braces, clear aligners, etc., often requires reciprocal forces that must be provided by an elastic component that pull two structures closer together, e.g., such as a rubber band, spring, or other stretchable or reversibly expandable component (sometimes referred herein as an “elastic” or “elastic module”). In orthodontics, there are elastic components that are designed to be frequently changed by a user (e.g., daily), infrequently changed by the patient user, and those changed only by the orthodontist. Usually, one or more elastic components are used for moving the upper and lower dental arches into improved (e.g., closer) front to back horizontal positions relative to each other. This means that if upper teeth are positioned too forward relative to lower teeth (horizontally), an elastic worn from near front upper teeth attached to lower back teeth would be needed.

Few orthodontists would disagree that patient non-adherence to orthodontic treatment protocol poses a significant added treatment risk that can lead to destructive oral health outcomes in the short-term and long-term. Patient non-adherence to orthodontic treatment protocols often is manifested in the form of deficient oral hygiene and/or deficient wear of orthodontic headgear, aligners, elastic components and removable appliances as prescribed. Elastic non-compliance is especially problematic as elastic components only begin to work after a threshold of wear of 18 hours per day is met. Patients wearing them for 18 or fewer hours per day derive no benefit for bite correction at all. In these cases, treatment frequently runs far beyond a two-year case duration, sometimes extending care to 3 or 4 years. Moreover, extended care can add further risk of irreversible damage to enamel, teeth roots damage, periodontal bone and soft tissues loss, appearance compromise, gum recession, temporomandibular joint (TMJ) instability, or even loss of teeth due to extend treatment. This costly damage is in addition to the failure to achieve the planned orthodontic correction.

Further complicating the task for the orthodontist is a lack of objective information about the degree to which patients are actually complying with the prescribed treatment regimen, particularly regarding the high time commitment threshold for wear of elastic modules to achieve successful results. What cannot be measured, cannot be managed. If adherence to elastic component protocol is not measurable, accountability for results is blurred. Treatment often runs far longer than planned in elastic component non-compliant cases, especially with child patients distracted by the challenges of adolescence. This multiplies added risk of damage, for example, because neither the orthodontist nor the patient truly knows the facts of how much the elastic component(s) are or are not being worn. Understanding compliance with elastic component wear would help to define accountability and allow more effective solutions—if only in measuring non-compliance as a means to objectively substantiate wiser decisions to reduce further risk by terminating treatment with non-compliant patients.

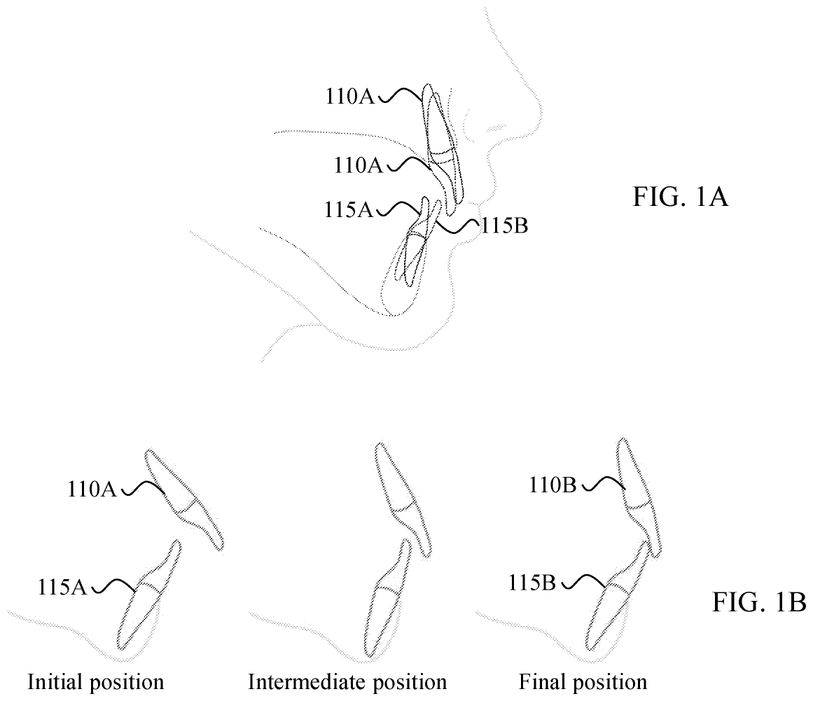

FIGS. 1A and 1B show examples of the movement of the upper and lower teeth based on using an orthodontic article or treatment. As shown in FIG. 1A, the resultant forces move upper teeth 110 backward as lower teeth 115 move forward into improved positions (from their initial positions indicated by solid lines 110A, 115A to their final positions indicated by dashed lines 110B, 115B).

Elastic components can also be used to achieve the reverse front to back correction like that illustrated in FIG. 1A. For example, elastic components can be used to move upper front teeth forward with lowers being moved backward by reversing the positions of elastics worn, e.g., which can be achieved by connecting elastics close to lower front teeth that stretches to upper back teeth.

These elastic components, also referred to as interarch elastic modules (which can be rubber bands), serve the function of adjusting the position of a patient's bite and jaw properly. For braces, for example, the interarch elastic modules are connected to the brackets or archwires, usually by connecting a top tooth bracket with a bottom tooth bracket or archwire hook to hook. Some interarch elastic modules are typically replaced daily, since they are inexpensive and may endure a lot of wear and tear during use. Notably, the efficacy of an orthodontic treatment is heavily reliant on how much time a patient uses the interarch elastic modules.

FIG. 1B shows an example of the progression of the upper and lower teeth, shown at the initial stage (left), intermediate stage (center) and final stage (right) of the orthodontic treatment, which such progression only occurs when the patient uses the prescribed interarch elastic modules with continuous (and constant) daily use over a course of time to meet a critical temporal threshold. The example sequence of diagrams in FIG. 1B shows that as the treatment progresses, the upper teeth move backward as the lower teeth move forward into improved positions.

The biologic demands for this to happen are not a linear relationship in terms of the necessary time required to initiate a threshold cellular and structural change—regardless of forces involved. For example, when teeth are forced to shift by an orthodontic device, cells in the bone and soft tissue ‘remodel’ supporting structures in the trailing region of the tooth (e.g., region where there is the opposite of compressive forces on bone) to fill in new bone behind a moving tooth. Cells in the leading region of tooth movement (e.g., region where there are compressive forces upon bone) tear down barriers of existing bone to where the tooth is moving; but, this must be sustained by pressure until a threshold is met, which is a function of time to which the force is sustained. The time threshold for productive cellular change or orthodontic correction is at least 18 hours within a 24-hour day, for the prescribed time period (e.g., which can be weeks or months, depending on the planned movement). This means that if the elastic component(s) are worn every day for just less than 18 hours, no significant cellular change will occur, nor will any orthodontic correction occur because teeth will not move under such conditions.

Many patients either do not understand or accept this threshold and, consequently, do not wear their elastic components enough to produce the desired change (and instead, are susceptible to destructive outcomes). Often, this lack of adherence is not intentional by the patient, but rather due to simply not being aware of how many hours elastics are being worn. Therefore, treatment time can easily protract into extra months and sometimes years, of treatment, which adds risk of damage to teeth due to excessive time braces are being used. This inefficiency also can negatively affect business profits to the practitioner providing orthodontic care (e.g., doubling treatment time with poor compliance would diminish the effective fee by 50%).

Disclosed are apparatuses, systems and methods for monitoring adherence and compliance of orthodontic elastic component use by a patient. In some aspects, a monitoring device is configured to measure a parameter indicative of an elastic component being worn by an orthodontics patient utilizing an electronic sensor device or a mechanical sensor device configured with the patient's orthodontics article (e.g., braces, clear aligners, or other).

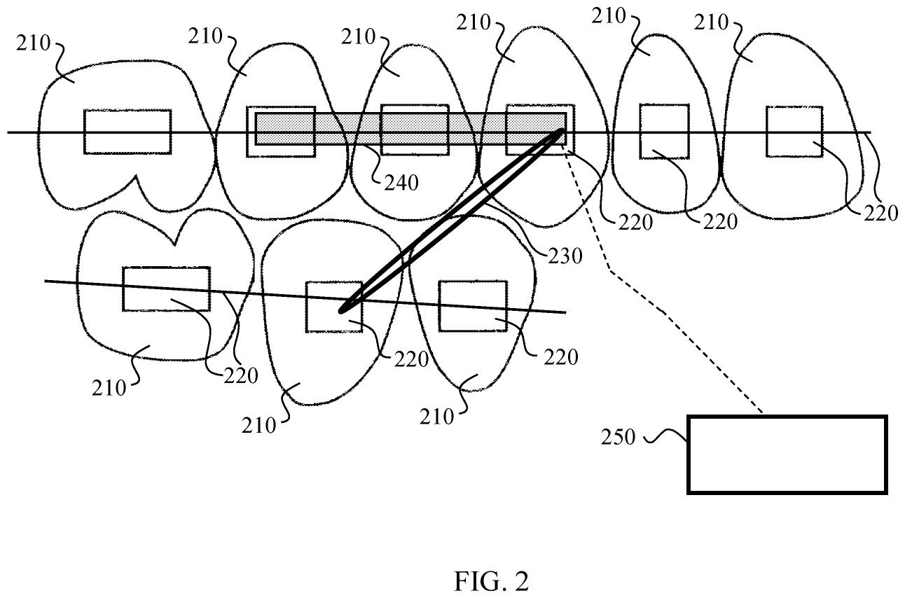

FIG. 2 shows a block diagram of an example embodiment of an orthodontic elastic component monitoring device in accordance with the disclosed technology, labeled 240, shown with an elastic component in use with an orthodontic article. As shown in FIG. 2, an orthodontic article (220), e.g., dental braces, has orthodontic components attached to a patient's (or user's) teeth (210), some of which are typically connected by an elastic component (230) that forms a crucial part of the orthodontic treatment. The monitoring device (240) is affixable to the patient's teeth, the orthodontic article (220), and/or the elastic component (230), which can be used to monitor parameters associated with the usage of the elastic component by the patient, and report information associated with the usage parameters to an external receiver (250). The monitoring device (240) includes a sensor configured to detect a presence of the elastic component (230) in applied with the orthodontic article (220) and/or to measure one or more properties of the elastic component (230) or of the orthodontics article (220) when the elastic component (230) is applied indicative of its use and/or its efficacy. In some embodiments, the monitoring device (240) can include a power supply, such as a battery or a biofuel cell, to supply electrical power to the sensor. In some embodiments, the sensor of the monitoring device (240) includes an electro-mechanical sensor, such as a strain gauge or a rate sensor (e.g., accelerometer or gyro sensor) to transduce a mechanical property or parameter of the elastic component (230) into an electrical signal output. In some embodiments, the monitoring device (240) can include a data processing, storage, and/or output unit to process, store, and/or offload raw or processed data obtained by the sensor. In some implementations, embodiments of the orthodontic elastic component monitoring device in accordance with the disclosed technology are directed to monitoring the usage of interarch elastics in orthodontic treatments to determine for how long the elastics are worn by the patient.

In some embodiments, the sensor of the monitoring device (240) includes a mechanical sensor that undergoes a mechanical property change in response to its monitoring of usage of the elastic component (230). For example, the monitoring device (240) can include a daily disposable monitoring device (240) that includes the mechanical sensor (e.g., which may come in a periodic set, such as monthly), where the patient user inserts a new disposable monitoring device (240) to couple with the elastic component (230) on a daily basis, placing the used monitoring device (240) in an example receiver (250) that can determine the mechanical change of the mechanical sensor meets a threshold indicative of adherence and compliance of usage of the elastic component (230) by the user. In some implementations, the mechanical property change can include a tensile property, an elongation, a deformation, a hardness of region(s), or other property of the mechanical sensor. For example, the example receiver (250) can include a camera or optical sensor to optically determine the change in the mechanical property of the mechanical sensor of the example disposable monitoring device (240). The example receiver (250) can include a data processing unit to process such data to determine adherence or compliance of elastic component use and/or output the data to another external device, such as a computing device, to process the data and determine the adherence and compliance of elastic component use of the patient user. In such embodiments using a mechanical sensor, the monitoring device (240) may not include the power supply or the data processing, storage, and/or output unit.

In some example embodiments, the monitoring device (240) includes an electro-mechanical sensor that, when the elastic component (230), e.g., rubber band, spring or other, is in its appropriate place of use with the orthodontics article (220), indicates the elastic component (230) is under a tensile load, e.g., sometimes referred to as the elastic sensor. The elastic sensor transmits data associated with the measurement indicative of the elastic component (230) (e.g., data corresponding to elastic force) for processing to determine use of the elastic component (230) with the orthodontics article (220). The data from the elastic sensor can be stored, processed, and/or transmitted from the device (240) to the receiver (250), e.g., by wireless communication (e.g., Bluetooth, Bluetooth Low Energy (BLE), near field communication (NFC), or other radio signal emission or wireless protocol).

In some embodiments, the elastic sensor includes a sensing mechanism that measures a physical property of the elastic component (230), e.g., including but not limited to mechanical stress, strain on the stretchability and elasticity of the elastic component (230). In some embodiments, the elastic sensor includes a switching mechanism that triggers an altering pattern based on an elastic property of the elastic component (230). In implementations, the switching mechanism is coupled to or integrated with a hooking mechanism on the orthodontic device (220) (e.g., orthodontic hook) that secures the elastic component (230) when in use, such that changes in the tension applied by the elastic component (230) on the orthodontic hook trigger the switching mechanism to toggle between two signals (e.g., on/off) which are recorded by a data recorder of the elastic sensor. In some implementations, for example, the altering pattern of the switching mechanism can be stored within the device and/or uploaded to an analyzing receiver. In some examples, the receiver (e.g., receiver 250) can include a cell phone or intermediary processor of a wearable device (such as bracelet, necklace, other jewelry or accessory forms or an addition/modification of an intraoral appliance).

In some example implementations of the device (240) where the elastic sensor includes the switching mechanism, a no-load (default) position of the switching mechanism may record more frequent signals or a unique pattern of signals that are different from a tensile-loaded pattern of signals when the elastic component (230) is worn with the orthodontics article (220). The analyzed data measured by the switching mechanism distinguishes non-use from usage of the elastic component (230) with the orthodontic article (220), e.g., from the differing frequency or patterns of signals. For example, the recorded signals (signal data) can be sent to a processor for comparison to a tension position of the switch. The signal data can be stored, analyzed and/or displayed for graphical, aural, e-mail, texting or any electronic reporting to provide information regarding the use of the elastic component (230) with the orthodontic article (220), e.g., for adherence and/or compliance monitoring by the device (240).

In some example implementations of the device (240) where the elastic sensor includes the switching mechanism, switch activation (wearing elastics) causes less energy drain of a power supply (e.g., battery, biofuel cell) within the monitoring device (240) because signals would be less frequent when the sensor is under tensile loading. In this manner, the elastic sensor can determine elastic adherence and compliance by analyzing the power supply level, e.g., which can be in addition to or alternative from the frequency or patterns of signals generated by the switching mechanism. Also, in this manner, the elastic sensor can manage and conserve the power drawn from the power supply while still monitoring adherence and compliance of the elastic component (230).

For example, in some implementations, the switching mechanism of the elastic sensor may operate in a gradient pressure mode (e.g., able to generate 1 to thousands of signals per minute) for measuring properties of the elastic component (230) and/or adherence and compliance. For example, for the gradient pressure mode, the switching mechanism toggles between states for every elastic elongation and compression cycle exhibited by the elastic component (230) due to the patient's use of it. In this manner, the gradient pressure mode can be used not only to determine adherence and compliance, but also parameters associated with the elastic itself Alternatively, in some implementations, the switching mechanism may operate in a two-signal mode (i.e., no tension state or tension state) for measuring properties of the elastic component (230) and/or adherence and compliance, e.g., which can conserve power. For example, for the two-signal mode, when tension is detected by the switching mechanism, the switch may be shut down for a duration (e.g., a half hour) and re-enabled after the shutdown duration to detect another elastic tension, such that two signals generations per hour would signify elastic use for that hour, whereas no-tension within the two durations per hour would signify non-compliance with the elastic component use. In some implementations, there can be at least one signal per 24-hour period to confirm the power supply of the monitoring device has power on any given day, e.g., to mitigate any false results (where the patient was using the elastic, but the switching mechanism was off due to battery failure). For example, the difference in power draw may be 48× conserved by the two-signal mode relative to the gradient pressure mode. In some examples, a wider signal interval (1 time for every 2 hours) can be employed in the two-signal mode to further conserve battery draw.

In some implementations, the data processing unit can apply statistical analysis of the elastic sensor signal output, including for two-signal mode, to interpret the usage, which may lessen power draw. Also, for example, statistical probability can lessen the need for closely-spaced intervals, such as 15 seconds or 30 seconds, if needed. A force exceeding a few Newtons on the trigger will “turn off” (reduce) the production of signal emission. Some degree of tension change can be built in, as the switch could theoretically be overridden by wax or other block out. Also, pattern of change can matter in reflecting wear habits, e.g., such as a clock within the sensor chip can monitor pattern changes with a time stamp. For example, if consistent “wear signals” were happening at usual meal times, this can signify an over-riding of sensor by the patient unless more obvious “non-wear” time windows imply different meal times (of non-wear).

In some embodiments, a data processing unit of the monitoring device (240) can monitor the power source. For example, if the battery drain is too much with signals being sent every second to a receiver (e.g., 60× per minute), the interval of the sent signals can be changed to two times per minute, three times per minute, ten times per minute, one time per 10-minutes, or other interval. The processing unit can be configured to process patterns in the sensor signal output, transmission interval rate, and power supply level and performance to identify an appropriate interval to transmit data and/or measure the elastic usage. For example, the data processing unit can identify meal times and be programmed not to transmit signals at meal times. The processing unit can employ statistical analysis to ascertain probability of elastics wearing as prescribed, particularly when the intervals are too wide.

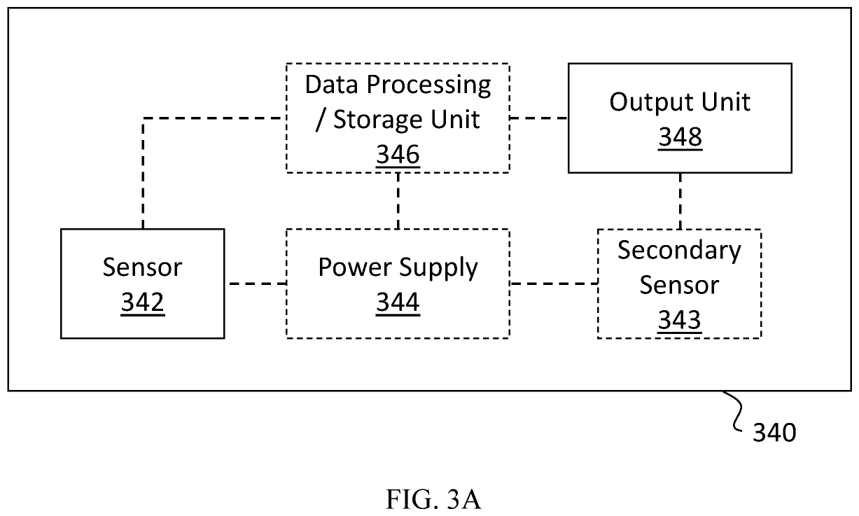

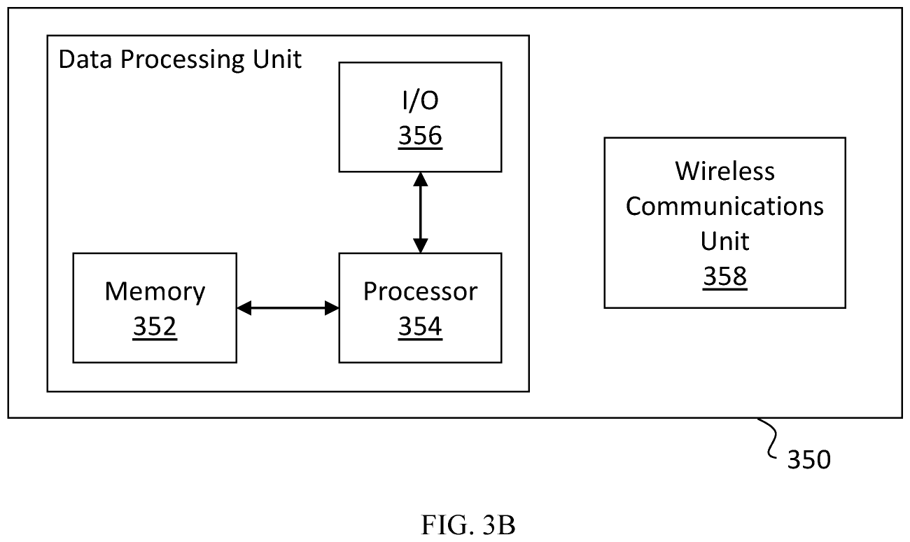

FIGS. 3A and 3B show block diagrams of example components and/or modules of a sensor device and a processing device for orthodontic elastic component monitoring in accordance with the disclosed technology, labeled (340) and (350), respectively. In some embodiments, the monitoring device (240) shown in FIG. 2 includes the components and/or modules of a sensor or monitoring device (340) shown in FIG. 3A; and the receiver (250) shown in FIG. 2 includes the components or modules of an external data processing unit or receiver (350) shown in FIG. 3B.

Referring to FIG. 3A, components and modules of the example sensor or monitoring device (340) includes a sensor (342) to detect one or more parameters of the elastic component (230) indicative of its usage (e.g., being worn or not) with the orthodontics article (220) and generate associated measurements and/or signals representative of information about the elastic component (230). The monitoring device (340) can include a data processing and/or storage unit (346) that processes and/or stores the measurements and/or signals (information). In some embodiments, the data processing/storage unit (346) includes a processor and memory to store the raw signal data from the sensor (342) in memory. In some implementations, the data processing/storage unit (346) can process the raw signal data to amplify, digitize, time stamp, and/or buffer the signal data. In some implementations, the data processing/storage unit (346) can further process the data to determine a relationship of the measured parameter(s) of the elastic component (230) with a time duration of its usage with the orthodontic article (220) to provide an output indicative of a patient user's adherence and/or compliance in wearing the elastic component (230). The monitoring device (340) can include an output unit (348) configured to output/transmit the measurements and/or signals (information) from the sensor 342 (and/or, in some implementations of embodiments including the data processing/storage unit (346), the processed data from the sensor and/or output. In some embodiments, the monitoring device (340) includes a power supply (344) that supplies power to one or more of the aforementioned components.

In some example embodiments of the sensor (342), the sensor (342) includes a sensing mechanism that detects one or more parameters of the elastic component (230) and/or a switching mechanism that is able to toggle between two states indicative of the elastic component (230) being worn or not.

In some embodiments, for example, the power supply (344) may be a MEMS-based non-regenerative power supply or a MEMS-based regenerative energy harvesting device. Examples of the MEMS-based regenerative energy harvesting device as the power supply (344) may include (i) kinetic energy harvesting that involves conversion of mechanical energy into electrical energy, wherein environmental displacements (e.g., kinetic energy source) are coupled with a transduction mechanism (e.g., energy is generated from the relative displacement or mechanical strain between the fixed inertial frame and the attached mass), and/or (ii) piezoelectric materials that produce an electrical charge when subjected to mechanical loads.

The monitoring device (340) can include a secondary sensor (343) to detect a second parameter associated with the elastic component (230) or to detect a parameter associated with the mouth environment, such as temperature, moisture, pH, or salivary analytes. In various implementations using the secondary sensor (343), the secondary sensor (343) can provide valuable data for verifying the validity of the adherence and/or compliance output determined from processing the sensor (342) measurement data. In this manner, the secondary sensor (343) can prevent a patient user from ‘cheating’ the elastic component monitoring device (343) by ‘tricking’ the sensor (342) to measure data similar to an elastic property parameter of the elastic component (230) while not actually or properly wearing the monitoring device (340). For example, in some embodiments, the secondary sensor (343) can include a temperature sensor to determine whether the monitoring device (340) is present in the patient user's mouth, e.g., by outputting the detected temperature measurement to the data processing/storage unit (346) and/or the output unit (348) that the environment's temperature is in a range of 37° C. plus/minus 0.1 or more ° C. In some embodiments, the secondary sensor (343) can include a moisture sensor to determine whether the monitoring device (340) is present in the patient user's mouth, e.g., by outputting the detected moisture measurement to the data processing/storage unit (346) and/or the output unit (348) that the environment's moisture level is consistent with a benchmark level for saliva. In some embodiments, the secondary sensor (343) can include a pH sensor to determine whether the monitoring device (340) is present in the patient user's mouth, e.g., by outputting the detected pH measurement to the data processing/storage unit (346) and/or the output unit (348) that the environment's pH level is consistent with a benchmark level for the human mouth. In some embodiments, the secondary sensor (343) can include a chemical sensor (e.g., an electrochemical sensor) to determine whether the monitoring device (340) is present in the patient user's mouth, e.g., by outputting the detected chemical (e.g., electrochemical) measurement to the data processing/storage unit (346) and/or the output unit (348) that one or more chemical constituents (e.g., analytes) of saliva are present in the environment of the monitoring device (340).

In some embodiments, the power supply (344) may include a battery to provide electrical energy (e.g., DC) to the one or more components of the monitoring device (340). For example, the battery can be shielded to prevent leaching of chemicals from the battery into the mouth. In some embodiments, the power supply (344) may include a non-battery power system to provide a DC voltage to the other components. For example, the non-battery power system can include a tuned LC circuit, a Schottky diode rectifier and a low power, low dropout regulator that provides a constant DC voltage with two capacitors at its input and output, such as the example described by Lantada et al. in Sensors (Basel), 12(9), 2012 and in PCT Publication No. 2009/013371A1, the entire contents of which are incorporated by reference in this patent document. In some embodiments, for example, the power supply (344) may include a salivary biofuel cell operable to harvest electrical energy from electrochemical reactions of salivary analytes with an anode and cathode of the biofuel cell. In some embodiments, the power supply (344) can include a printed biofuel cell for harvesting electrical energy from analytes in saliva as described in U.S. Pat. No. 9,502,730B2, entitled “PRINTED BIOFUEL CELLS”, the entire content of which is incorporated by reference in this patent document. In some implementations, an example secondary chemical sensor (343) can include the biofuel cell by monitoring energy harvesting to indicate the monitoring device (340) is in the mouth environment for monitoring adherence and compliance of the elastic component (230).

In some embodiments, the data processing/storage unit (346) may be optional since the measurements and/or information can be transmitted as soon as they are generated by the output unit (348). In other embodiments, the output unit (348) may be optional since the device may be detached from the orthodontic article and placed in a docking station to access, download and process all the information.

In some embodiments, the sensor (342) can include an accelerometer, a rate sensor, a plurality of position sensors, or other sensor to measure motion associated with the elastic component (230) directly and/or the orthodontic article (220), e.g., to which motion of the orthodontic article (220) can be distinguished when the elastic component (230) is properly coupled or not to the orthodontic article (220) in accordance with the prescribed orthodontic treatment. In some embodiments, the sensor (342) can include a tension load cell, a force-sensing resistor (FSR), a strain gauge or other tensile sensor to measure tensile property associated with the elastic component (230). For example, the sensor (342) can include a microelectromechanical systems (MEMS)-based strain gauge, a piezoresistive MEMS strain sensor. Yet, in some embodiments, the sensor (342) can include an optical sensor to determine a presence and/or activity of the elastic component (230) when properly coupled to the orthodontic article (220). For example, the sensor (342) can include a beam generator at a first monitoring device (340A, not shown) attached to an upper or lower part of the orthodontic article (220) and a beam receiver at a second monitoring device (340B, not shown) separately attached to the opposite lower or upper part of the orthodontic device (220), such that the beam would be received when the elastic component (230) is not in use due to obstruction of the beam when the elastic component (230) is in use. In various implementations of the monitoring device (340), the sensor (342), such as the embodiments of the tensile sensor, can be coupled to a switching mechanism such that the sensor (342) causes the triggering of the switch so that the elastic component (230) can be monitored based on the gradient pressure mode and/or the two-signal mode as described above.

FIG. 3B shows the example external data processing unit or receiver (350) that communicates with the monitoring device (340) shown in FIG. 3A. In some example embodiments, the components and modules of the receiver (350) can include a data processing unit comprising a processor (354), a memory (352), and an input/output (I/O) interface (356). Such embodiments of the receiver (350) provide a data processing unit operable to process and store data, such as data produced by the monitoring device (340), and transfer the data to an output device or display. In some example embodiments, the receiver (350) may optionally include a wireless communications unit (358) to facilitate wireless data communication with the monitoring device (340) and/or other devices. For example, the monitoring device (340) can use a wireless communication protocol to transmit data measured by the sensor (342) (and/or secondary sensor (343)) to the receiver (350). Similarly, the monitoring device (340) can receive updates and instructions from the receiver (350). In some embodiments, for example, the receiver (350) may include a cell phone or intermediary processor worn (such as bracelet, necklace, other accessory or jewelry forms or an addition/modification of an intraoral appliance). In some embodiments, the monitoring device (340) may include the processor (354), the memory (352), and/or the input/output (I/O) interface (356) as part of the data processing/storage unit (346).

For example, in some example embodiments, the receiver (350) may optionally include an implantable microchip (e.g., implanted in tissue within the patient user's mouth, such as in the cheek) to receive data from (and/or transmit data to) the monitoring device (340) wirelessly and subcutaneously. In some examples, the monitoring device (340) can use lower power wireless communication protocol like NFC to transmit data measured by the sensor (342) (and/or secondary sensor (343)) to the example implantable receiver (350), by which the implantable receiver (350) can employ a higher power wireless communication protocol like Bluetooth, BLE or other to transmit to an external computing device and/or display device, e.g., like a smartphone, tablet, smartwatch, laptop or desktop computer, etc.

In some implementations, the processor (354) can include a central processing unit (CPU) or a microcontroller unit (MCU). For example, the memory (352) can include and store processor-executable code, which when executed by the processor, configures the data processing unit (e.g., data processing/storage unit (346) of the monitoring device (340) and/or the data processing unit of the receiver (350)) to perform various operations, e.g., such as receiving information, commands, and/or data, processing information and data, and transmitting or providing information/data to another device. To support various functions of the data processing unit, the memory (352) can store information and data, such as instructions, software, values, images, and other data processed or referenced by the processor (354). For example, various types of Random Access Memory (RAM) devices, Read Only Memory (ROM) devices, Flash Memory devices, and other suitable storage media can be used to implement storage functions of the memory (352). In some implementations, the data processing unit includes the input/output (I/O) unit (356) to interface the processor (354) and/or memory (352) to other modules, units or devices, e.g., associated with the monitoring device and/or other external devices. In some embodiments, the data processing unit includes a wireless communications unit (358), e.g., such as a transmitter (Tx) or a transmitter/receiver (Tx/Rx) unit. For example, in such embodiments, the I/O unit (356) can interface the processor (354) and memory (352) with the wireless communications unit (358), e.g., to utilize various types of wireless interfaces compatible with typical data communication standards, which can be used in communications of the data processing unit with other devices, e.g., such as between the one or more computers in the cloud and the user device. The data communication standards include, but are not limited to, Bluetooth, Bluetooth Low Energy (BLE), Zigbee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE/5G cellular communication methods, and parallel interfaces. In some implementations, the data processing unit can interface with other devices using a wired connection via the I/O unit (356). The data processing unit can also interface with other external interfaces, sources of data storage, and/or visual or audio display devices, etc. to retrieve and transfer data and information that can be processed by the processor (354), stored in the memory (352), or exhibited on an output unit of the user device (e.g., smartphone) or an external device.

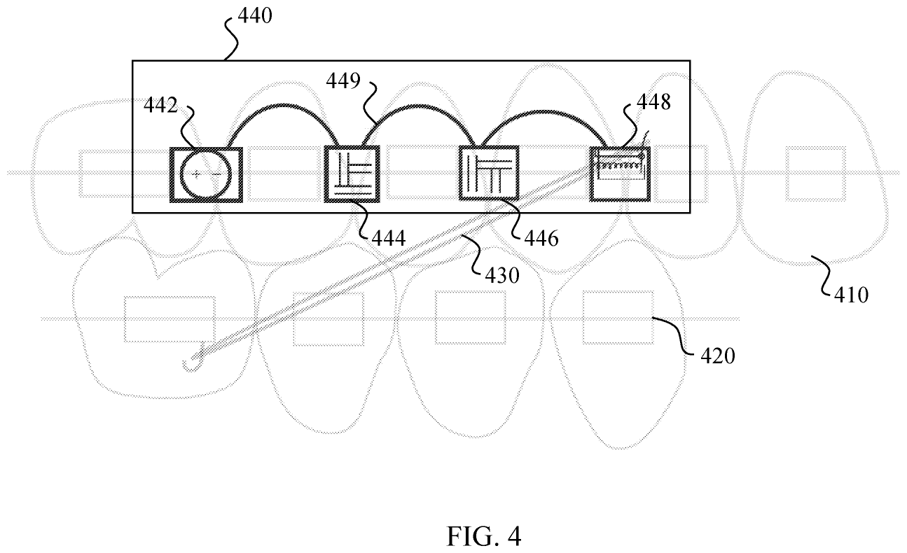

FIG. 4 shows a diagram of an example embodiment of an elastic component monitoring device in accordance with the disclosed technology, labeled 440. This example includes at least some features and/or components of the monitoring device described in connection with the monitoring device (240) shown in FIG. 2 or the monitoring device (340) shown in FIG. 3A, or in other embodiments described herein. Some of these features and/or components may be separately described in connection with embodiments shown in FIG. 4 and/or other embodiments disclosed herein.

In the example shown in FIG. 4, the monitoring device (440) includes a power supply (442), one or more circuits (shown as first circuit board (444) and second circuit board (446)), and a sensor or switch (448), which may be connected using wires (449). In other embodiments, the sub-components of the monitoring device may be co-located. As described earlier, the power supply (442), e.g., battery, supplies power to the sensor/switch (448), which is able to toggle between two states to detect whether an elastic component (430) is being worn or not and generate associated measurements and/or information.

In some embodiments, the one or more circuits (444, 446, which may be implemented as microelectromechanical systems (MEMS)-based components) may support a wireless communication unit, or more generally support the functionality of the output unit (348) in FIG. 3. In other embodiments, the one or more circuits may support limited computation or processing capabilities that may be able to process the collected raw measurements prior to outputting them (e.g., signal processing functions).

In some embodiments, the sensor (448) may be a MEMS-based component, and is generally configured to monitor how long a patient is using the elastic component. In an example, the sensor may include a toggle switch that simply toggles between “wearing” and “not wearing” options. In an example, the sensor may support detecting an increase in a tension of a strain gauge. In another example, the sensor may support detecting an increase in a resistance of a piezoresistive strain sensor. In yet another example, the sensor may support detecting a change in the relative locations of position sensors.

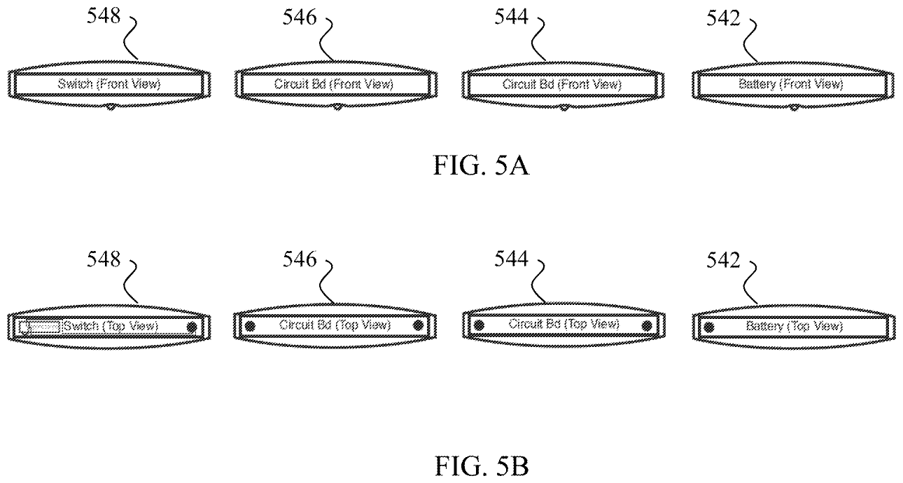

FIGS. 5A and 5B show different views of examples of the example device for orthodontic elastic component monitoring shown in FIG. 4. These examples may include some features and/or components that are similar to those shown in FIGS. 2, 3A-3B and 4, described above. The sub-components of the monitoring device may include the switch (548), one or more circuit boards (544, 546) and a battery (542), and exhibit a very minimal profile, as illustrated in FIGS. 5A and 5B. The minimal size and profile of the monitoring device advantageously enables it to be used in various orthodontic articles including, but not limited to, clear aligners, dental braces and headgear. In some embodiments, the minimal size and profile of the monitoring device can be approximately 5 mm×5 mm rectangle (or rounded diameter), or less, and have a 2 mm thickness, or less.

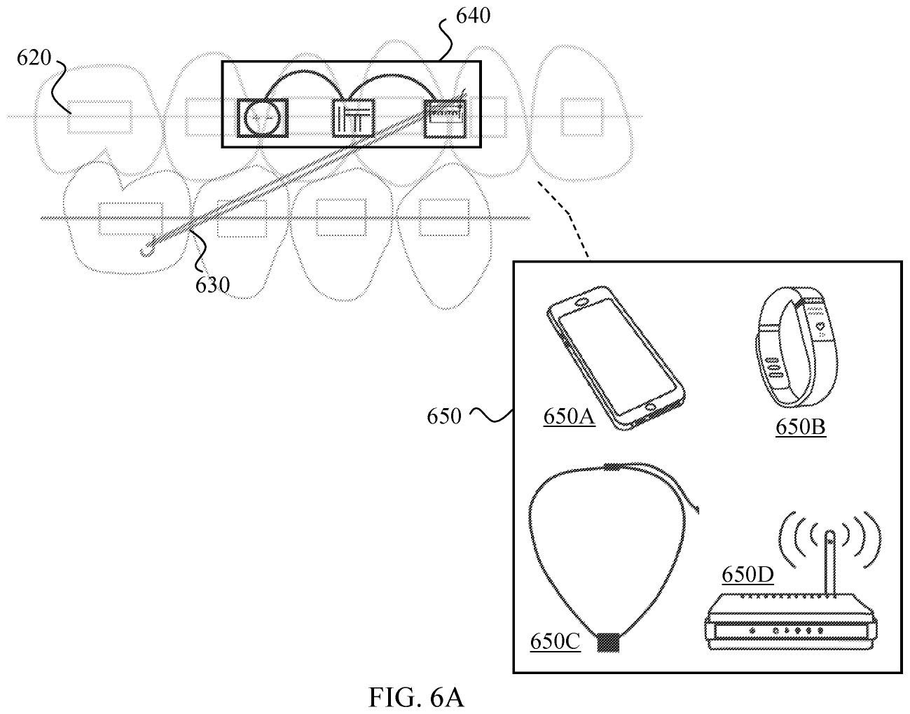

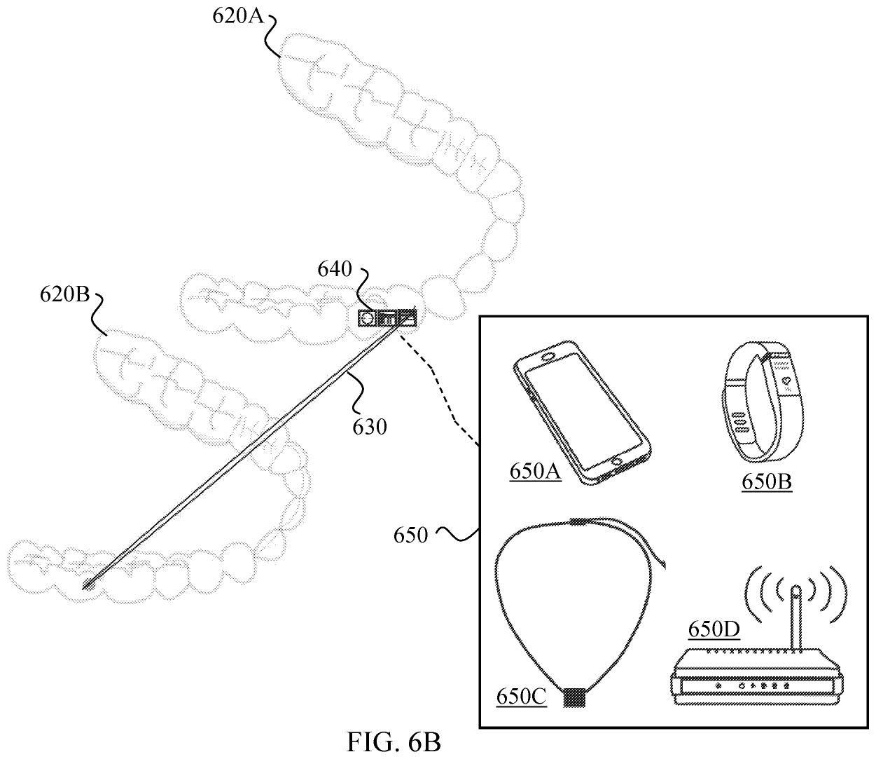

FIGS. 6A and 6B show diagrams of different exemplary use cases of the example device for orthodontic elastic component monitoring shown in FIG. 4. These examples include some features and/or components that are similar to those shown in FIGS. 2, 4 and 5, and described above.

FIG. 6A shows the monitoring device (640), described in the context of FIG. 4, affixed to dental braces (620), and in communication with a receiver (650) that may be a cellphone (650A), a wearable device (650B) like a smartwatch (e.g., Fitbit, Jawbone, Apple Watch, or other), a jewelry or accessory article (650C), and/or a wireless communication and/or computing device (650D), e.g., a modem, laptop, PC, tablet, etc.

FIG. 6B shows the monitoring device (640), described in the context of FIG. 4, affixed to upper and lower clear aligners (620A, 620B) as the orthodontic article, and in communication with a receiver (650) that may be the cellphone (650A), the wearable device (650B), the jewelry or accessory article (650C), and/or the wireless communication and/or computing device (650D).

In some embodiments, and as shown in FIGS. 6A and 6B, the monitoring device (640) may be affixed to the upper portion of the orthodontic article, which is coupled to the lower portion of the orthodontic article using the elastic component (630). In other embodiments, the monitoring device (640) may be affixed to the lower portion of the orthodontic article. In yet other embodiments, the elastic component may be between different teeth in the upper portion (or lower portion) only. More generally, embodiments of the disclosed technology are directed towards measuring a duration of usage of an elastic component of an orthodontic article, and may be adapted to the orthodontic treatment.

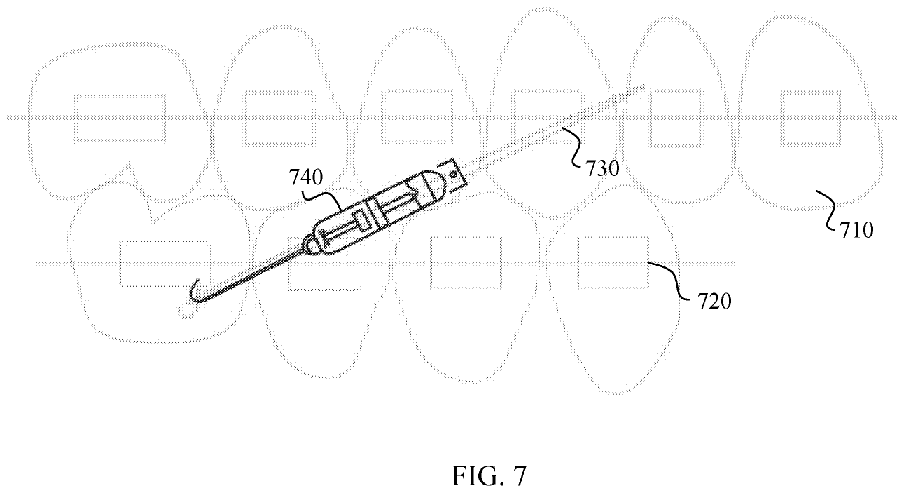

FIG. 7 shows a diagram of an example embodiment of an elastic component monitoring device in accordance with the disclosed technology, labeled 740. This example includes at least some features and/or components of the monitoring device described in connection with the monitoring device (240) shown in FIG. 2, the monitoring device (340) shown in FIG. 3A, and/or the monitoring device (440) shown in FIG. 4, or in other embodiments described herein. Some of these features and/or components may be separately described in connection with embodiments shown in FIG. 7 and/or other embodiments disclosed herein.

In some embodiments, the monitoring device (740) shown in FIG. 7 has the same or similar functionality as the monitoring device (440) described in the context of FIG. 4, but has a different form factor that can attach directly to or integrated in an interarch elastic component (730). In some example embodiments, the monitoring device (740) can be coupled to the elastic component (730) at one end of the elastic component (730), in which the monitoring device (740) includes a hook that couples to orthodontic article (720) at the hook end and to the monitoring device's sensor at the other end (e.g., elastic sensor that includes the switching mechanism). In this example, the monitoring device (740) can be pulled by the elastic component (730). In some embodiments, the elastic component (730) can include a spring that may be encased in a thin, soft coating; whereas in some embodiments, the elastic component (730) can include a polymer band with elastic properties (e.g., a rubber band).

In some embodiments, the elastic component (730) can include a spring encased in a thin, soft coating that allows the spring to compress and elongate. The spring can be made of an electrically conductive material (e.g., metal). The soft coating encasement can provide a ground conductor line or plane, such that the spring can serve as an antenna for wireless transmission of the sensor signals, e.g., to a receiver (not shown).

As shown in FIG. 7, the orthodontic article (720) (e.g., dental braces) is attached to a patient's lower and upper teeth (710) and is connected via the elastic component (730) as part of the orthodontic treatment, and the monitoring device (740) with a “barrel” form factor is affixed to the elastic component (730), instead of the patient's teeth and/or the orthodontic article (as shown in the context of FIG. 4).

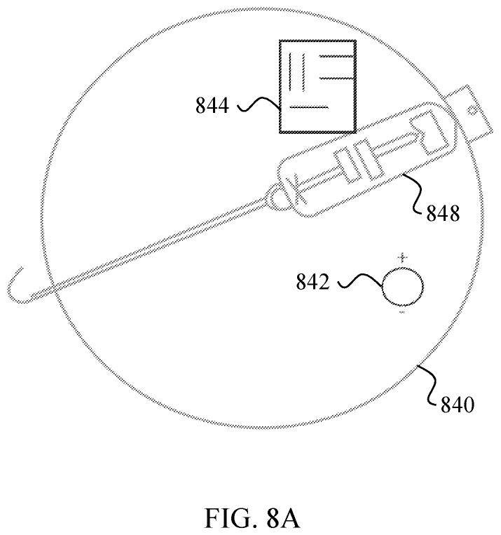

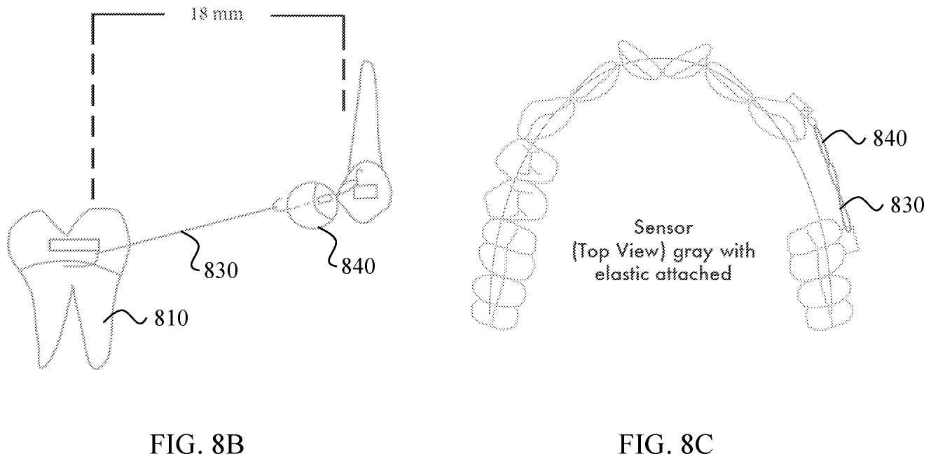

FIGS. 8A-8C show different views of example configurations of the of the example device for orthodontic elastic component monitoring shown in FIG. 7. These examples may include some features and/or components that are similar to those shown in FIGS. 2, 3A-3B, 4, 5A-5B and 7, and described above, and some of these features and/or components may not be separately described in this section.

FIG. 8A shows a monitoring device (840) that includes an electrical switch (848), which can be used in the sensor in some embodiments, such as the monitoring device (740) in FIG. 7, a battery (842), and a circuit board (844) encapsulated in a rubber base, which can be disposed within a housing (e.g., plastic). In this embodiment, the distortion of the rubber base inside plastic housing would actuate switch. The rubber base isolates saliva from contacting any electrical components. The broad diameter of the housing might make comfort better as P=F/A. In some embodiments, the monitoring device (840) may be waterproof while having a barrel design of 2 mm diameter or less and with a length between 3.5 to 5 mm.

FIG. 8B shows an example embodiment with monitoring device (840) with the rubber base and housing directly connected to one end of an elastic component (830) between two teeth in different planes, e.g., between the upper and lower planes. In an embodiment, the elastic component (830) and coupled monitoring device (840) can span approximately 18 mm, or less or greater depending on mouth size or orthodontic treatment configuration.

FIG. 8C shows an alternate view where the monitoring device (840) is affixed to the elastic component (830), which is connected to two teeth in the same plane (e.g., only in the upper set of teeth, or only in the lower set of teeth). As shown in FIGS. 8B and 8C, the monitoring device (840) is affixed to the hook attached to the tooth, and includes another hook which connects to the elastic component (830) that connects to the other tooth.

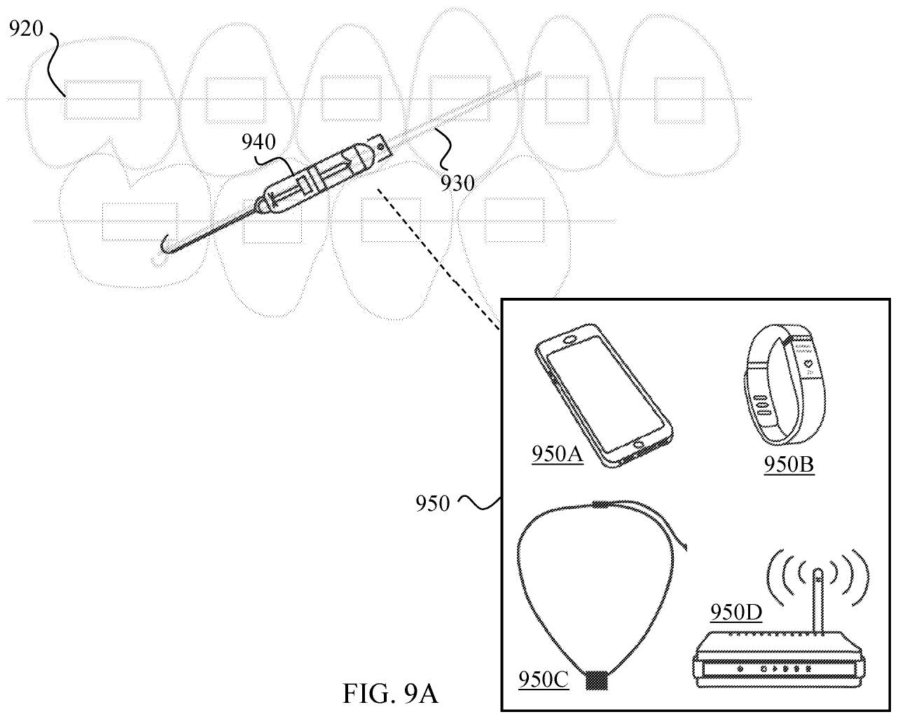

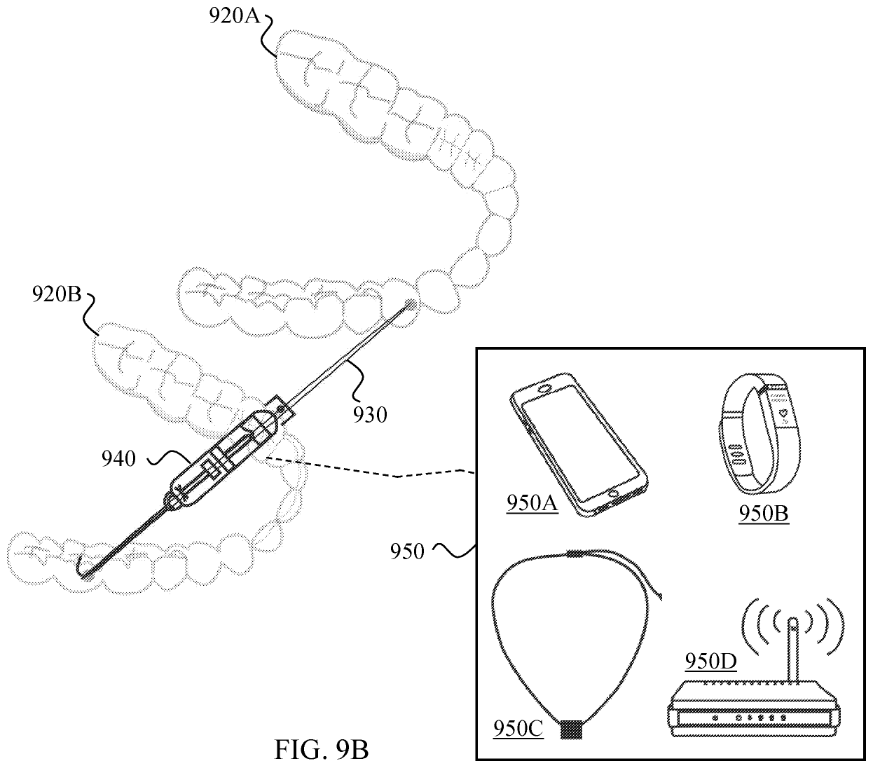

FIGS. 9A and 9B show diagrams of different exemplary use cases of the example device for orthodontic elastic component monitoring shown in FIG. 7. These examples include some features and/or components that are similar to those shown in FIGS. 2, 7 and 8A-8C, and described above.

FIG. 9A shows the monitoring device (940), described in the context of FIG. 7, integrated or coupled to the elastic component (930) which is attached to dental braces (920). The monitoring device (940) is in communication with a receiver (950) that may be a cellphone (950A), a wearable device (950B) such as a smartwatch (e.g., Fitbit, Jawbone, Apple Watch, or other), an accessory or jewelry article (950C), and/or a wireless communication and/or computing device (950D), e.g., a modem, laptop, PC, tablet, etc.

FIG. 9B shows the monitoring device (940), described in the context of FIG. 7, integrated or coupled to the elastic component (930) which is attached to upper and lower clear aligners (920A, 920B) as the orthodontic article. The monitoring device (940) is in communication with a receiver (950) that may be the cellphone (950A), the wearable device (950B), the accessory or jewelry article (950C), and/or the wireless communication or computing device (950D).

The disclosed technology may be configured to communicate the usage of the interarch elastics in various embodiments. For example, and as described above, one exemplary method may be a gradient pressure mode (with a range of 1 to thousands of signals per minute) or two signal modes: no tension with 2 signals per hour (48/day) or tension with 1 signal per 24 hrs. In other embodiments, and leveraging the wireless communication capabilities of existing MEMS-based components, digital communication modulation methods may be used to communicate the “wearing” and “not wearing” states. For example, binary frequency shift keying (binary FSK), which uses a pair of discrete frequencies, may be used. More generally, any binary antipodal signaling scheme may be used to transmit this information. In yet other embodiments, the signaling scheme may be periodic. In yet other embodiments, the signaling scheme may be configured to only indicate a change in state (e.g., from “wearing” to “not wearing”, and vice versa) and may be transmitted with a timestamp.

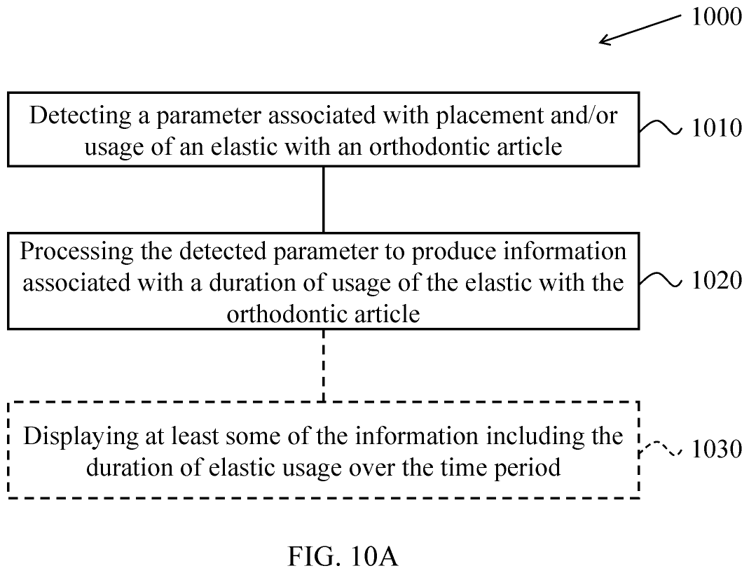

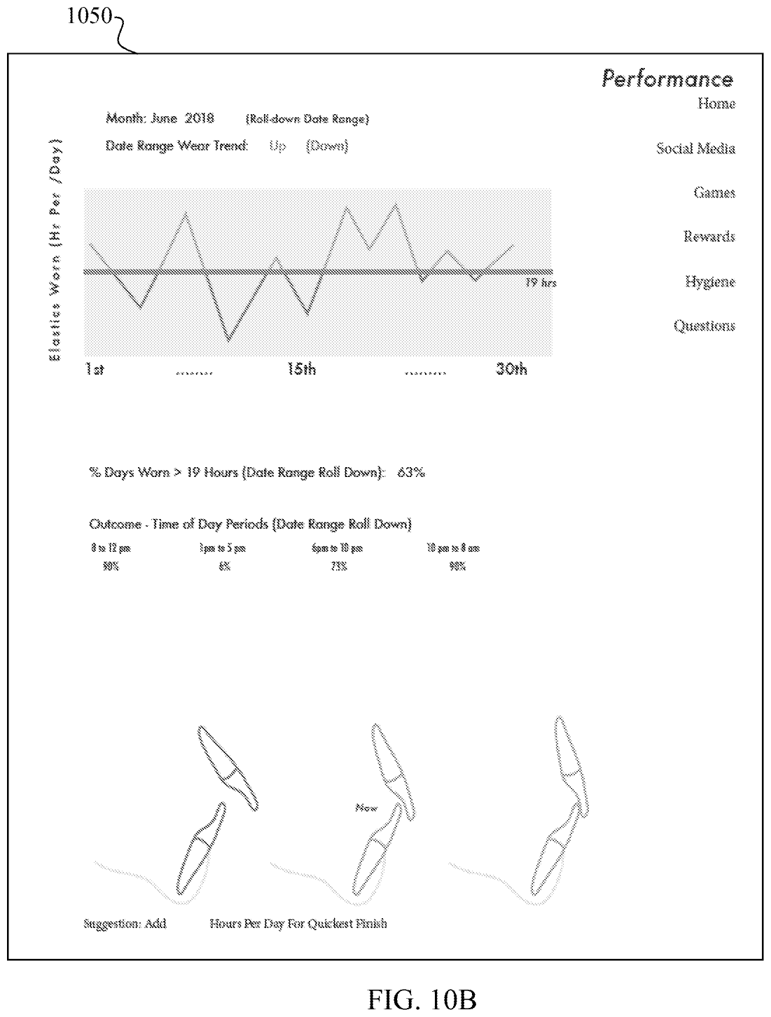

FIG. 10A shows a flowchart of an exemplary method for monitoring an elastic component of an orthodontic article. The method 1000 includes, at process 1010, detecting a parameter associated with placement and/or usage of an elastic component with an orthodontic article. In some embodiments, the detecting is performed by the example embodiments of the monitoring device as described above (e.g., such as by a toggle switch coupled to a sensor). The method 1000 includes, at process 1020, processing the detected parameter to produce information associated with a duration of usage of the elastic component with the orthodontic article. In some implementations of the method 1000, a data logger of the monitoring device may be used to record signal data obtained by the sensor for subsequent processing to produce the information. In some implementations of the process 1020, a data processing unit processes the signal data to produce the information, which can include a time duration of use of the elastic component over a time period, e.g., such as 19 hours over a 24-hour time period. In some examples, the time duration can include elastic component usage and non-usage times over the time period to depict the continuity of elastic component usage over the time period. In some implementations of the method 1000, the information may be generated using processing resources that are available on the monitoring device, and may then be transmitted to an external receiver. In other implementations, the information and/or measurements may be filtered prior to the duration being computed. In yet other implementations, the raw measurements may be transmitted, and any subsequent processing may be performed on the external receiver.

In some embodiments of the method 1000, the method 1000 may optionally include, at process 1030, displaying at least some of the information including the duration of elastic component usage over the time period to a user, such as the patient and/or a caregiver. In some implementations, for example, the process 1030 can include generating a report or a notification, e.g., via the receiver device, indicative of a current time duration over the time period, a summary of usage over a greater time period, and/or a reminder to apply/use the elastic component to the orthodontic article.

FIG. 10B shows a diagram of an example report associated with orthodontic elastic component monitoring, labeled 1050. The example report (1050) can include a time chart depicting a wear trend of an elastic component over a time period, a summary of days worn above a predetermined threshold (e.g., 19 hours per day), and/or a graphic illustrating teeth movement with and without sufficient use of the elastic component. For example, the graphic includes a graphical plot summary of daily performance, which can include icons, colors or other graphical indicators for identifying the weakest time block(s) and/or strongest time blocks of usage with elastics in the time period (e.g., day). The example report (1050) can include a percentage of time worn, e.g., including overall since last appointment; recommendations for any added hours needed; and/or a forecast on months remaining to finish bite correction at current pace.

In various implementations of the process 1030, for example, the report and/or notifications can include periodic or intermittent e-mails that are automatically generated, e.g., to encourage top-of-mind awareness about orthodontic care—that the “team” is thinking about the patient. In some implementations, for example, the report and/or notifications can include short, positive stories that can be reminders for following through on the challenges with remembering to wear elastics, e.g., including occasional shared stories from other users in the country on their experience. In some implementations, for example, there could be brief explanations of biological aspects of tooth movement. In some implementations, for example, random “updates” (no more than a paragraph), followed by asking the patient to call to the orthodontic office if there are any concerns going on.

Embodiments of the disclosed technology may be affixed in a permanent or semi-permanent state (e.g., as described in the context of FIG. 4), and may be occasionally removed for servicing or updating. Alternatively, the monitoring device may be affixed to the elastic component (which may be changed regularly), and may be designed to be easily removable so as to be able to switch the monitoring device to different elastics.

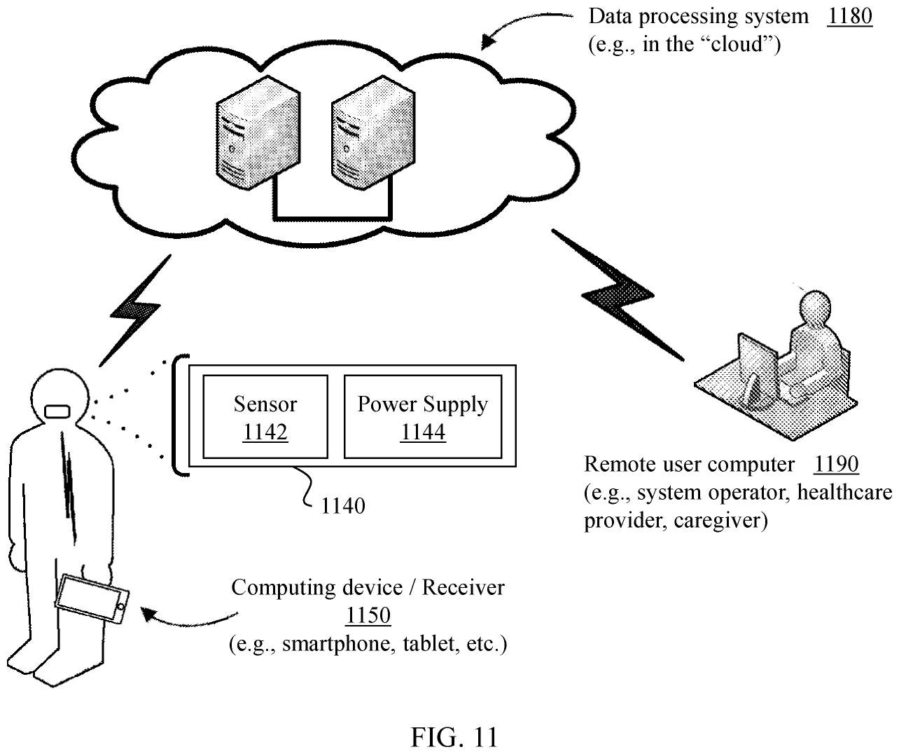

FIG. 11 shows a diagram of an example embodiment of a system in accordance with the disclosed technology that integrates the device for orthodontic elastic component monitoring with remote devices and cloud-based services. The exemplary system includes a device for orthodontic elastic component monitoring (1140), which is an example embodiment of the monitoring device (240) shown in FIG. 2, to monitor usage of the elastic component (230) with the orthodontics article (220) by the user/patient. The example device (1140) includes a sensor (1142) and a power supply (1144), which in some embodiments, may be in communication with a data processing and/or storage unit and output unit (not shown). The exemplary system includes a receiver (1150), which is an example embodiment of the receiver (250) shown in FIG. 2, to receive, process and/or display information associated with the monitoring by the monitoring device (1140). In some implementations, for example, the receiver (1150) can be resident on a computing device, such as a mobile computing device, e.g., a smartphone, tablet and/or wearable computing device (e.g., smartwatch, smartglasses, etc.), or a computer including a laptop or desktop computer. The system may further include a data processing system (1180) in communication with the receiver (1150) of the monitoring device (1140). In an example, such as that shown in FIG. 11, the monitoring device (1140) communicates data obtained by the sensor/switch of sensor 1142 to the receiver (1150) (e.g., a user's smartphone or tablet), which can process the obtained data for display on the smartphone or tablet and/or for transference to an external computer or computing system, such as the data processing system (1180). In the example, the user having the smartphone or tablet can include the patient user wearing the monitoring device (1140) or another user, such as an orthodontist, dentist, parent or significant other, or other health care provider or caregiver.

In some embodiments, for example, the system includes a remote user computer (1190) to remotely monitor data associated with the user obtained by the monitoring device (1140) and transferred to the data processing system (1180), and/or to remotely operate aspects of the system. For example, the remote user computer (1190) can include a personal computer such as a desktop or laptop computer, a mobile computing device such as a smartphone, tablet, smartwatch, etc., or other computing device.

In such embodiments, for example, the system includes a software application (“app”) that is stored on the computer device (or receiver, 1150) of the user (e.g., patient user and/or other user such as a physician) and controls the processing and storage of the data received from the monitoring device (1140) using the processor and memory of the user computer device (or receiver, 1150). In some embodiments, the data processing system (1180) includes one or more computing devices in a computer system or communication network accessible via the Internet (referred to as “the cloud”), e.g., including servers and/or databases in the cloud. In some embodiments, the data processing system (1180) can be embodied on the user device (e.g., smartphone). Similarly, in some embodiments of the system, for example, the data processing system (1180) includes the one or more computing devices in the cloud and the app resident on the user device to receive and manage data processing of the data obtained from the monitoring device (1140). In some implementations, for example, the monitoring device (1140) transfers data to a user computing device, e.g., using a low power wireless communication protocol (e.g., BLE), in which the app can control various data processing of the received data; and the app can transfer the data to the one or more computing devices in the cloud using a different communication protocol, e.g., including a wired or a wireless communication protocol such as LTE, Wi-Fi, or other. In other implementations, for example, the monitoring device (1140) transfers data after being placed in a docking station (not shown in FIG. 11).

### EXAMPLES

In some embodiments in accordance with the disclosed technology (example A1), an apparatus for monitoring elastics usage with an orthodontic article includes a sensor to detect a signal associated with an elastic article when coupled to the orthodontic article, wherein the sensor is affixable to the orthodontic article or to the elastic article; and a data logger in communication with the sensor to record information associated with the detected signal.

Example A2 includes the apparatus of example A1 or any subsequent examples, wherein the data logger includes a wireless transmitter configured to periodically transmit the information; and a power source configured to provide power to the wireless transmitter.

Example A3 includes the apparatus of any of the preceding or subsequent examples, wherein the data logger further comprises: a wireless receiver configured to receive the information.

Example A4 includes the apparatus of any of the preceding or subsequent examples, wherein the wireless transmitter supports a Bluetooth protocol, a Bluetooth Low Energy (BLE) protocol, a Zigbee protocol, a near field communications (NFC) protocol, or an IEEE 802.15-based protocol.

Example A5 includes the apparatus of any of the preceding or subsequent examples, wherein the power source includes regenerative power source and/or a non-regenerative power source.

Example A6 includes the apparatus of any of the preceding or subsequent examples, wherein the data logger includes a docking station configured to store the information when the sensor is in proximity with the docking station.

Example A7 includes the apparatus of any of the preceding or subsequent examples, wherein the sensor includes a microelectromechanical systems (MEMS)-based strain gauge, a piezoresistive MEMS strain sensor, a plurality of position sensors, or a switch.

Example A8 includes the apparatus of any of the preceding examples, wherein the orthodontic article includes a clear aligner, dental braces, or an orthodontic headgear.

In some embodiments in accordance with the disclosed technology (example A9), a method for monitoring elastics usage with an orthodontic article includes detecting a usage of an elastic article of the orthodontic article over time; and recording the detected usage and generating duration information associated with the detected usage.

Example A10 includes the method of example A9 or any of the subsequent examples, wherein detecting the usage of the elastic article comprises detecting that a switch, coupled to the elastic article, has been toggled.

Example A11 includes the method of example A10, wherein detecting the switch has been toggled is based on an increase in a tension of a strain gauge.

Example A12 includes the method of example A10, wherein detecting the switch has been toggled is based on an increase in a resistance of a piezoresistive strain sensor.

Example A13 includes the method of example A10, wherein detecting the switch has been toggled is based on a change in the relative locations of one or more position sensors.

Example A14 includes the method of any of the preceding or subsequent examples, comprising processing the duration information to determine whether the usage of the elastic article exceeds a predetermined temporal threshold.

Example A15 includes the method of example A14, wherein the temporal threshold includes at least 18 hours.

Example A16 includes the method of any of the preceding or subsequent examples, wherein the duration information associated with the detected usage is transmitted to a healthcare provider.

Example A17 includes the method of example A16, comprising processing the information to alert or instruct the healthcare provider to update an orthodontic treatment based on the duration.

Example A18 includes the method of any of the preceding or subsequent examples, wherein detecting the usage of the elastic article comprises detecting an increase in an activity of resistance of a piezoelectric-resistive accelerometer sensor coupled to the elastic article.

Example A19 includes the method of any of the preceding or subsequent examples, wherein detecting the usage of the elastic article comprises detecting pattern shifts of an electrical frequency sensor.

Example A20 includes the method of any of the preceding or subsequent examples, wherein detecting the usage of the elastic article comprises detecting a change in the physical constitution of the elastic article itself of a physical compositional sensor.

Example A21 includes the method of any of the preceding or subsequent examples, wherein detecting the usage of the elastic article is based on an energy harvesting sensor generating voltage output.

Example A22 includes the method of any of the preceding or subsequent examples, wherein detecting the usage of the elastic article is based on a change in the relative positional locations of sensor sub-components.

Example A23 includes the method of any of the preceding examples, wherein the orthodontic article includes a clear aligner, dental braces, or an orthodontic headgear.

Example A24 includes the device of any of examples A1-A8 to implement the method in any of examples A9-A23.

In some embodiments in accordance with the disclosed technology (example B1), an apparatus for monitoring elastics usage with an orthodontic article includes a sensor to detect a physical parameter associated with an elastic component when the elastic component is coupled to the orthodontic article, wherein the sensor is attachable to the orthodontic article or to the elastic article and operable to transduce the detected physical parameter into an electrical signal; a data processing unit, comprising a processor and a memory, in communication with the sensor to receive the electrical signal from the sensor and to process the electrical signal as data to be stored or transmitted by the apparatus; and a power source to supply power to the sensor and to the data processing unit.

Example B2 includes the apparatus of any of the preceding or subsequent examples B1-B24, wherein the data processing unit comprises a wireless transmitter configured to periodically or intermittently transmit the data.

Example B3 includes the apparatus of any of the preceding or subsequent examples B1-B24, further comprising a wireless receiver external from the apparatus configured to receive the transmitted data from the wireless transmitter.

Example B4 includes the apparatus of any of the preceding or subsequent examples B1-B24, wherein the wireless receiver comprises a docking station operable to store the information when the sensor and/or data processing unit of the apparatus is in proximity with the docking station for wireless transmission or electrically connected with the docking station.

Example B5 includes the apparatus of any of the preceding or subsequent examples B1-B24, wherein the data is transmitted based on a Bluetooth protocol, a Bluetooth Low Energy (BLE) protocol, a Zigbee protocol, a near field communication (NFC) protocol, or an IEEE 802.15-based protocol.

Example B6 includes the apparatus of any of the preceding or subsequent examples B1-B24, wherein the power source includes a regenerative power source or a non-regenerative power source.

Example B7 includes the apparatus of any of the preceding or subsequent examples B1-B24, wherein the non-regenerative power source includes a battery operable to store electrical energy.

Example B8 includes the apparatus of any of the preceding or subsequent examples B1-B24, wherein the regenerative power source includes a biofuel cell operable to generate electrical energy from salivary analytes.

Example B9 includes the apparatus of any of the preceding or subsequent examples B1-B24, wherein the sensor includes a tension load cell, a force-sensing resistor (FSR), and/or a strain gauge to measure a tensile property associated with the elastic component.

Example B10 includes the apparatus of any of the preceding or subsequent examples B1-B24, wherein the apparatus further comprises a switch coupled to the sensor and configured to toggle between two states based on the signal outputted by the sensor.

Example B11 includes the apparatus of any of the preceding or subsequent examples B1-B24, wherein the switch is configured to operate in a gradient pressure mode that generates a toggle signal for each change in a tensile property detected by the sensor.

Example B12 includes the apparatus of any of the preceding or subsequent examples B1-B24, wherein the switch is configured to operate in a two-signal mode correspond to a no-tension state and a tension state, wherein the switch is configured to be shut down for a shutdown duration subsequent to a toggle signal of the switch in response to a change in a tensile property detected by the sensor, and wherein the switch is configured to be re-enabled after the shutdown duration to generate another toggle signal in response to another change in the tensile property detected by the sensor.

Example B13 includes the apparatus of any of the preceding or subsequent examples B1-B24, wherein the shutdown duration includes a 30-minute duration such that the switch may toggle twice per hour to indicate the elastic component is coupled to the orthodontic article, thereby conserving the power from the power source.

Example B14 includes the apparatus of any of the preceding or subsequent examples B1-B24, wherein the sensor includes an accelerometer, a rate sensor, and/or a plurality of position sensors to measure motion associated with the elastic component.

Example B15 includes the apparatus of any of the preceding or subsequent examples B1-B24, wherein the sensor includes an optical sensor to determine a presence and/or activity of the elastic component when it is coupled to the orthodontic article.

Example B16 includes the apparatus of any of the preceding or subsequent examples B1-B24, further comprising a secondary sensor to detect a second physical parameter associated with the elastic component or to detect a parameter associated with an intra-mouth environment.

Example B17 includes the apparatus of any of the preceding or subsequent examples B1-B24, wherein the secondary sensor includes a temperature sensor to determine whether the apparatus is present in the mouth of a patient user by measuring a temperature at or around 37° C. plus or minus 1° C.

Example B18 includes the apparatus of any of the preceding or subsequent examples B1-B24, wherein the secondary sensor includes a moisture sensor to determine whether the apparatus is present in the mouth of a patient user by measuring a moisture level or range consistent with a benchmark level for saliva.

Example B19 includes the apparatus of any of the preceding or subsequent examples B1-B24, wherein the secondary sensor includes a pH sensor to determine whether the apparatus is present in the mouth of a patient user by measuring a pH level or range consistent with a benchmark level for saliva.

Example B20 includes the apparatus of any of the preceding or subsequent examples B1-B24, wherein the secondary sensor includes a chemical sensor to a chemical or an electrochemical measurement indicative that one or more chemical constituents of saliva are present at the secondary sensor.

Example B21 includes the apparatus of any of the preceding or subsequent examples B1-B24, wherein the data processing unit of the apparatus or a data processing unit of an external computing device comprising instructions executable by a processor is operable to process the detected physical parameter to estimate a time duration the elastic component was coupled with the orthodontic article during the time period, and to determine whether the time duration meets or exceeds a predetermined temporal threshold.

Example B22 includes the apparatus of any of the preceding or subsequent examples B1-B24, wherein the predetermined temporal threshold includes at least 18 hours for a 24-hour period.

Example B23 includes the apparatus of any of the preceding or subsequent examples B1-B24, wherein the elastic component includes a rubber band or a spring.

Example B24 includes the apparatus of any of the preceding examples B1-B23, wherein the orthodontic article includes a clear aligner, dental braces, or an orthodontic headgear.

In some embodiments in accordance with the disclosed technology (example B25) a method for monitoring elastics usage with an orthodontic article includes detecting, over a time period, a parameter associated with usage of an elastic article when the elastic article coupled to the orthodontic article; processing the detected parameter to estimate a time duration the elastic article was coupled with the orthodontic article during the time period; and determining whether the time duration meets or exceeds a predetermined temporal threshold.

Example B26 includes the method of example B25, wherein the predetermined temporal threshold includes at least 18 hours and the time period includes 24 hours.

Example B27 includes the method of any of examples B25 to B26, wherein detecting the parameter associated with the usage of the elastic article includes recording one or more toggles by a switch coupled to the elastic article.

Example B28 includes the method of example B27, wherein detecting the switch has been toggled is based on one of a change in a tension upon a strain gauge, a change in a resistance of a piezoresistive strain sensor, or a change in motion of an accelerometer or rate sensor.

Example B29 includes the method of any of examples B25 to B26, wherein the detecting the parameter associated with the usage of the elastic article includes one or more of motion detection, tensile detection or optical detection of the elastic article.

Example B30 includes the method of any of examples B25 to B29, comprising transmitting the determined time duration associated with usage of the elastic article coupled to orthodontic article to a computing device associated with a patient user of the orthodontic article and/or a dental or orthodontal care provider of the patient user.

Example B31 includes the method of any of examples B25 to B30, comprising generating an alert or instruction when the determined time duration does not satisfy the predetermined temporal threshold indicative of non-compliance of elastics usage to be displayed on the computing device.

Example B32 includes the method of any of examples B25 to B31, wherein the elastic article includes a rubber band or a spring.

Example B33 includes the method of any of examples B25 to B32, wherein the orthodontic article includes a clear aligner, dental braces, or an orthodontic headgear.

Example B34 includes the method of any of examples B25 to B33, wherein the method is implantable by the apparatus of any of examples B1-B24.

In some embodiments in accordance with the disclosed technology (example C1), an apparatus for monitoring elastics usage with an orthodontic article includes a sensor to detect a physical parameter associated with an elastic component when the elastic component is coupled to the orthodontic article, wherein the sensor is attachable to the orthodontic article or to the elastic article and operable to transduce the detected physical parameter into an electrical signal; and a power source to supply power to the sensor and to the data processing unit.

Example C2 includes the apparatus of example C1, further including a data processing unit, comprising a processor and a memory, operable to process the electrical signal as data, wherein the data processing unit is coupled to the sensor, or wherein the data processing unit is remote from the sensor and in wireless communication with a transmitter of the apparatus in communication with the sensor.

Example C3 includes the apparatus of example C2, wherein the apparatus includes a feature or features and/or is configured to operate in accordance with the apparatus of any of examples B1-B24.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms “a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. An apparatus for monitoring elastics usage with an orthodontic article, comprising:
a sensor to detect a physical parameter associated with an elastic component when the elastic component is coupled to the orthodontic article, wherein the sensor is attachable to the orthodontic article or to the elastic article and operable to transduce the detected physical parameter into an electrical signal;
a data processing unit, comprising a processor and a memory, in communication with the sensor to receive the electrical signal from the sensor and to process the electrical signal as data to be stored or transmitted by the apparatus; and
a power source to supply power to the sensor and to the data processing unit.

2. The apparatus of claim 1, wherein the data processing unit comprises:
a wireless transmitter configured to periodically or intermittently transmit the data.

3. The apparatus of any of claim 1 or 2, further comprising:
a wireless receiver external from the apparatus configured to receive the transmitted data from the wireless transmitter.

4. The apparatus of claim 3, wherein the wireless receiver comprises a docking station operable to store the information when the sensor and/or data processing unit of the apparatus is in proximity with the docking station for wireless transmission or electrically connected with the docking station.

5. The apparatus of any of claims 1 to 4, wherein the data is transmitted based on a Bluetooth protocol, a Bluetooth Low Energy (BLE) protocol, a Zigbee protocol, a near field communication (NFC) protocol, or an IEEE 802.15-based protocol.

6. The apparatus of any of claims 1 to 5, wherein the power source includes a regenerative power source or a non-regenerative power source.

7. The apparatus of claim 5, wherein the non-regenerative power source includes a battery operable to store electrical energy.

8. The apparatus of claim 5, wherein the regenerative power source includes a biofuel cell operable to generate electrical energy from salivary analytes.

9. The apparatus of any of claims 1 to 8, wherein the sensor includes a tension load cell, a force-sensing resistor (FSR), and/or a strain gauge to measure a tensile property associated with the elastic component.

10. The apparatus of any of claims 1-9, wherein the apparatus further comprises a switch coupled to the sensor and configured to toggle between two states based on the signal outputted by the sensor.

11. The apparatus of claim 10, wherein the switch is configured to operate in a gradient pressure mode that generates a toggle signal for each change in a tensile property detected by the sensor.

12. The apparatus of claim 10, wherein the switch is configured to operate in a two-signal mode correspond to a no-tension state and a tension state, wherein the switch is configured to be shut down for a shutdown duration subsequent to a toggle signal of the switch in response to a change in a tensile property detected by the sensor, and wherein the switch is configured to be re-enabled after the shutdown duration to generate another toggle signal in response to another change in the tensile property detected by the sensor.

13. The apparatus of claim 12, wherein the shutdown duration includes a 30-minute duration such that the switch may toggle twice per hour to indicate the elastic component is coupled to the orthodontic article, thereby conserving the power from the power source.

14. The apparatus of any of claims 1 to 8, wherein the sensor includes an accelerometer, a rate sensor, and/or a plurality of position sensors to measure motion associated with the elastic component.

15. The apparatus of any of claims 1 to 8, wherein the sensor includes an optical sensor to determine a presence and/or activity of the elastic component when it is coupled to the orthodontic article.

16. The apparatus of any of claims 1 to 15, further comprising:
a secondary sensor to detect a second physical parameter associated with the elastic component or to detect a parameter associated with an intra-mouth environment.

17. The apparatus of claim 16, wherein the secondary sensor includes a temperature sensor to determine whether the apparatus is present in the mouth of a patient user by measuring a temperature at or around 37° C. plus or minus 1° C.

18. The apparatus of claim 16, wherein the secondary sensor includes a moisture sensor to determine whether the apparatus is present in the mouth of a patient user by measuring a moisture level or range consistent with a benchmark level for saliva.

19. The apparatus of claim 16, wherein the secondary sensor includes a pH sensor to determine whether the apparatus is present in the mouth of a patient user by measuring a pH level or range consistent with a benchmark level for saliva.

20. The apparatus of claim 16, wherein the secondary sensor includes a chemical sensor to a chemical or an electrochemical measurement indicative that one or more chemical constituents of saliva are present at the secondary sensor.

21. The apparatus of any of claims 1 to 20, wherein the data processing unit of the apparatus or a data processing unit of an external computing device comprising instructions executable by a processor is operable to process the detected physical parameter to estimate a time duration the elastic component was coupled with the orthodontic article during the time period, and to determine whether the time duration meets or exceeds a predetermined temporal threshold.

22. The apparatus of claim 21, wherein the predetermined temporal threshold includes at least 18 hours for a 24-hour period.

23. The apparatus of any of claims 1 to 22, wherein the elastic component includes a rubber band or a spring.

24. The apparatus of any of claims 1 to 23, wherein the orthodontic article includes a clear aligner, dental braces, or an orthodontic headgear.

25. A method for monitoring elastics usage with an orthodontic article, comprising:
detecting, over a time period, a parameter associated with usage of an elastic article when the elastic article coupled to the orthodontic article;
processing the detected parameter to estimate a time duration the elastic article was coupled with the orthodontic article during the time period; and
determining whether the time duration meets or exceeds a predetermined temporal threshold.

26. The method of claim 25, wherein the predetermined temporal threshold includes at least 18 hours and the time period includes 24 hours.

27. The method of any of claims 25 to 26, wherein detecting the parameter associated with the usage of the elastic article includes recording one or more toggles by a switch coupled to the elastic article.

28. The method of claim 27, wherein detecting the switch has been toggled is based on one of a change in a tension upon a strain gauge, a change in a resistance of a piezoresistive strain sensor, or a change in motion of an accelerometer or rate sensor.

29. The method of any of claims 25 to 26, wherein the detecting the parameter associated with the usage of the elastic article includes one or more of motion detection, tensile detection or optical detection of the elastic article.

30. The method of any of claims 25 to 29, comprising:
transmitting the determined time duration associated with usage of the elastic article coupled to orthodontic article to a computing device associated with a patient user of the orthodontic article and/or a dental or orthodontal care provider of the patient user.

31. The method of any of claims 25 to 30, comprising:
generating an alert or instruction when the determined time duration does not satisfy the predetermined temporal threshold indicative of non-compliance of elastics usage to be displayed on the computing device.

32. The method of any of claims 25 to 31, wherein the elastic article includes a rubber band or a spring.

33. The method of any of claims 25 to 32, wherein the orthodontic article includes a clear aligner, dental braces, or an orthodontic headgear.
